(19) United States
(12) Patent Application Publication
(10) Pub. No.: US 2009/0072564 A1
(43) Pub. Date: Mar. 19, 2009

(54) CONVERTIBLE VEHICLE

(76) Inventor: Robert A. Teeple, Gibsonburg, OH (US)

Correspondence Address: FRASER CLEMENS MARTIN & MILLER LLC, 28366 KENSINGTON LANE, PERRYSBURG, OH, 43551, US

(21) Appl. No.: 12/210,630

(22) Filed: Sep. 15, 2008

Related U.S. Application Data
(60) Provisional application No. 60/972,301, filed on Sep. 14, 2007.

(51) Int. Cl. B60P 3/42; B60R 27/00

(52) U.S. Cl. 296/10

(57) ABSTRACT

A convertible vehicle adapted to selectively receive a plurality of attachments for performing various utility functions. The convertible vehicle including a vehicle frame adapted to support the convertible vehicle and a sub-frame coupled to the vehicle frame, the sub-frame including a coupling device adapted to releasably couple an attachment to the sub-frame.

### CROSS-REFERENCE TO RELATED APPLICATION

This application claims the benefit of U.S. provisional patent application Ser. No. 60/972,301, filed Sep. 14, 2007, hereby incorporated herein by reference in its entirety.

### FIELD OF THE INVENTION

The invention relates to vehicles. More particularly, the invention is directed to a convertible vehicle adapted to receive a plurality of attachments.

### BACKGROUND OF THE INVENTION

Currently, utility vehicles are manufactured to perform a particular function. For example, a dump truck includes a built-in dump bed for hauling load material and quickly dumping the load material. As another example, a utility truck may have a wrecker boom fixed to a rear portion of the truck. As such, the utility element (e.g. dump bed and wrecker boom) is permanently attached to the vehicle and the usefulness of the utility vehicle is limited to the functions of the utility element.

It would be desirable to have a convertible vehicle, wherein the vehicle is adapted to selectively receive a plurality of attachments for performing various utility functions.

### SUMMARY OF THE INVENTION

Concordant and consistent with the present invention, a convertible vehicle, wherein the vehicle is adapted to selectively receive a plurality of attachments for performing various utility functions, has surprisingly been discovered.

In one embodiment, a convertible vehicle comprises a vehicle frame adapted to support the convertible vehicle and a sub-frame coupled to the vehicle frame, the sub-frame including a coupling device adapted to releasably couple an attachment to the sub-frame.

In another embodiment, a convertible vehicle comprises a vehicle frame having a plurality of ground engaging wheels and a driver cabin, the vehicle frame adapted to support the convertible vehicle and a sub-frame coupled to the vehicle frame, the sub-frame including a coupling device adapted to releasably couple an attachment to the sub-frame.

In another embodiment, a convertible vehicle comprises a vehicle frame having a plurality of ground engaging wheels, a driver cabin, and a truck bed, wherein the vehicle frame is adapted to support the convertible vehicle and a sub-frame coupled to the truck bed, the sub-frame including a coupling device adapted to releasably couple an attachment to the sub-frame.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is an exploded perspective view of a convertible vehicle according to an embodiment of the present invention; and

FIG. 2 is an exploded perspective view of a convertible vehicle according to another embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

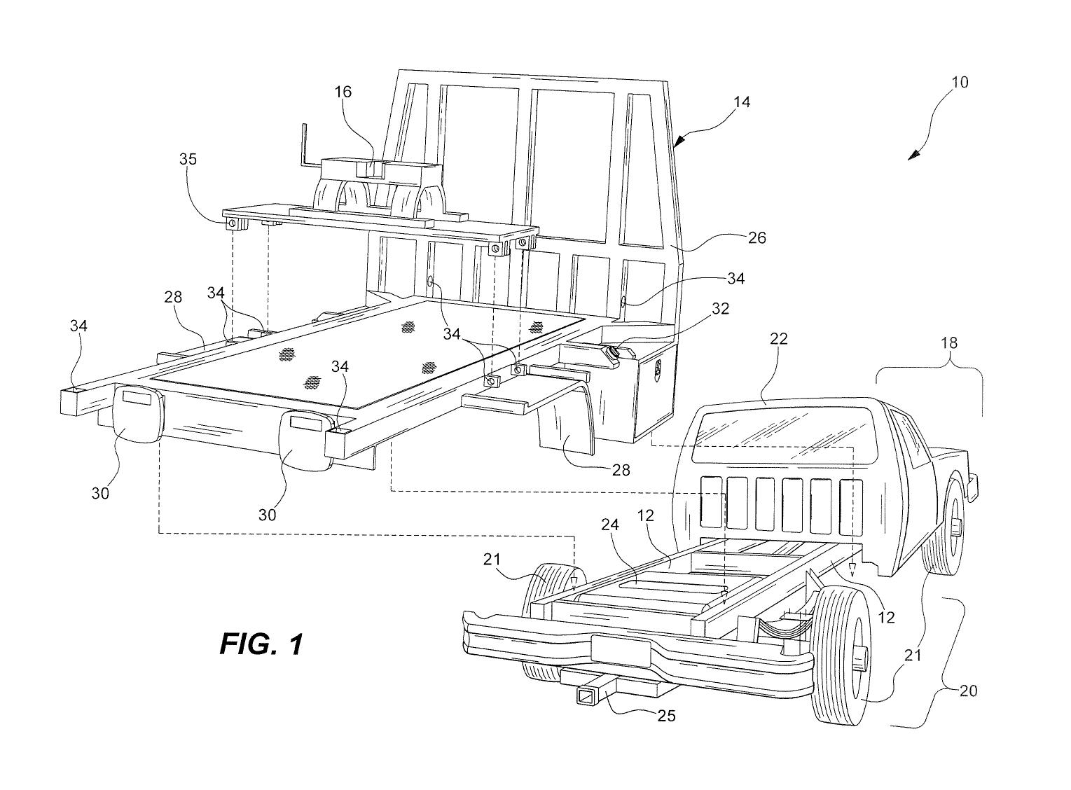

FIG. 1 shows a convertible vehicle 10 according to an embodiment of the present invention. In the embodiment shown, the convertible vehicle 10 includes a vehicle frame 12, a sub-frame 14, and an attachment 16.

The vehicle frame 12 is adapted to support the convertible vehicle 10. The vehicle frame 12 includes a front portion 18 and a rear portion 20. The each of the front portion 18 and the rear portion 20 of the vehicle frame 12 includes a plurality of ground engaging wheels 21. As shown, the front portion 18 of the vehicle frame 12 includes a driver cabin 22 similar to a truck cab conventionally used on utility vehicles. The rear portion 20 includes a fuel tank 24 similar to the conventional fuel tanks used in utility vehicles. Other driver cabins and fuel tanks may be used, as desired. As a non-limiting example, the vehicle frame 12 is shown including a hitch receiver 25 adapted to couple with various hitches, trailers, and devices as is know in the art. It is understood that the vehicle frame 12 may include additional components and features such as a hydraulic system, an electrical system, and a power take-off (PTO) system, as desired. Other components and systems, now known or later developed, may be included on the vehicle frame 12, as desired.

The sub-frame 14 is formed from metal and has a substantially rectangular shape. It is understood that the sub-frame 14 may be formed from any suitably material, as desired. It is further understood that the sub-frame 14 may have any shape and size, as desired. As shown in FIG. 1, the sub-frame 14 is coupled to the vehicle frame 12. It is understood that the sub-frame 14 may be coupled to the vehicle frame 12 in a single manufacturing procedure. It is further understood that the sub-frame 14 may be coupled to the vehicle frame 12 in a post-manufacturing procedure such as welding, bolting, and other sufficient fastening means, as desired.

In the embodiment shown in FIG. 1, the sub-frame 14 includes a headache rack 26, a plurality of fenders 28, a lighting system 30, a fuel inlet 32, and a plurality of coupling devices 34. It is understood that the sub-frame 14 may further include additional components and features such as a hydraulic system, an electrical system, an underbody tool box, a plurality of fenders, a pump, a motor, a cable winch, a gear reducer, a reservoir, a hose, a control system, a tag hitch receiver, a power supply, and a means to aid in the removal of the attachment 16 from the sub-frame 14. It is further understood that the components and systems of the sub-frame are adapted to interact with a systems and component of the vehicle frame 12. As a non-limiting example, the hydraulic system of the vehicle frame 12 may be adapted to cooperate with the hydraulic system of the sub-frame 14 to control the movement and functions of the attachment 16. Likewise, the electrical system of the sub-frame 14 may be interconnected to the electrical system of the vehicle frame 12. As a further example, the sub-frame 14 may also include a system or device for controlling a brake system for trailers and the like.

The headache rack 26 is disposed adjacent the driver cabin 22 and adapted to provide support for loads being carried on the sub-frame 14 of the convertible vehicle 10 as well as to protect a driver and any passengers from the load being carried or the attachment 16 coupled to the sub-frame 14. Specifically, components of the attachment 16 and other loose objects being carried on the sub-frame 14 can shift toward the driver cabin 22 and be projected through a rear window of the driver cabin 22 when the convertible vehicle 10 comes to a sudden stop or decelerates quickly. As such, the headache rack 26 provides a barrier between the load carried on the sub-frame 14 and the driver cabin 22 to minimize damage to the driver cabin 22 and injury to the driver and the passengers. As shown, the headache rack 26 is formed from metal and has a trapezoidal shape. However, it is understood that the headache rack 26 may be formed from any suitable material and may have shape and size, as desired.

The fenders 28 are formed from metal and define a wheel well. It is understood that the fenders 28 may be formed from any material and may have any shape, as desired. It is further understood that fenders 28 may include additional components and features, as desired.

The lighting system 30 is disposed on a visible surface of the sub-frame 14. As shown the lighting system 30 includes a plurality of tail lights that may be used a warning devices. It is understood that additional lights may be included such as side marker lights, for example. It is further understood that any number of lights, any type of light emitting device, and any size of light may be used as desired.

The fuel inlet 32 is in fluid communication with the fuel tank 24 of the vehicle frame 12. As such, the fuel inlet 32 provides an access point and a fluid conduit for a user to deliver vehicle fuel into the fuel tank 24. It is understood that the fuel inlet 32 may have any shape, size, and design, as appropriate.

The coupling devices 34 may be any device or system adapted to receive a portion of the attachment 16 and releasably secure the attachment 16 to the sub-frame 12. In the embodiment shown in FIG. 1, the coupling devices 34 are a plurality of coupler apertures formed in pre-determined locations throughout the sub-frame 14. As such, the sub-frame 14 includes a tapered guide system to guide a portion of the attachment 16 into the coupler apertures, wherein locking pins are used to releasably secure the attachment 16 in place. As a non-limiting example, the coupling devices 34 may be mounting brackets adapted to receive a conventional fifth wheel hitch or gooseneck hitch system. It is understood that any coupling device or mounting bracket may be used, as desired. It is further understood that any combinations of various coupling devices may be used, as desired.

The attachment 16 is a utility element adapted to be releasably coupled to the sub-frame 14. As shown the attachment 16 includes a plurality of adjustable mounting brackets 35 adapted to releasably couple to the coupling devices 34 of the sub-frame 14. In certain embodiments, the attachment 16 is interconnected to a system or component of the sub-frame 14 or vehicle frame 12. As a non-limiting example, the attachment 16 may be adapted to receive electrical power from the electric system of the sub-frame 14. As a further example, the attachment 16 may include components that are hydraulically driven by the hydraulic system of the sub-frame 14 or vehicle frame 12. It is understood that any means of coupling the components and systems of the sub-frame 14 and the vehicle frame 12 to the components of the attachment 16 may be used such as a quick-change device, for example. As shown in FIG. 1, the attachment 16 is a fifth wheel hitch coupled to the sub-frame 14 using conventional mounting brackets. However, the attachment 16 may be any device, system, or utility element such as a wrecker boom, a lift gate, a box bed, a lifting device, a motorcycle lift, a gooseneck hitch, a winch, a fork lift, a platform lift, a ramp, a dump bed, and a liquid tank, for example. Other devices and systems may be used, as desired.

In use, the sub-frame 14 is coupled to the vehicle frame 12 as a replacement to a conventional truck bed. The sub-frame 14 is releasably coupled to various quick-change attachments 16 that would normally be permanently fastened to the rear portion 20 of the vehicle frame 12. As such, various attachments 16 are interchangeably and releasably coupled to the sub-frame 14, and thereby the vehicle frame 12, for supporting the attachment 16. Once coupled, the attachment 16 may be used to perform various utility functions associated with the design and nature of the attachment 16. Where the user desires a new utility function, another attachment 16 may be releasably coupled to the sub-frame 14. In the embodiment shown in FIG. 1, the mounting brackets 35 of the attachment 16 engage the coupling devices 34 of the sub-frame 14 and locking pins are used to secure the attachment 16 to the sub-frame 14. The attachment 16 is further interconnected to the electrical system of the sub-frame 14 for providing electrical power to the attachment. It is understood that other means of releasably coupling the attachment 16 to the sub-frame 14 may be used, as desired. It is further understood that the attachment 16 may be interconnected to other systems and devices of the sub-frame 14 and vehicle frame 12, as desired.

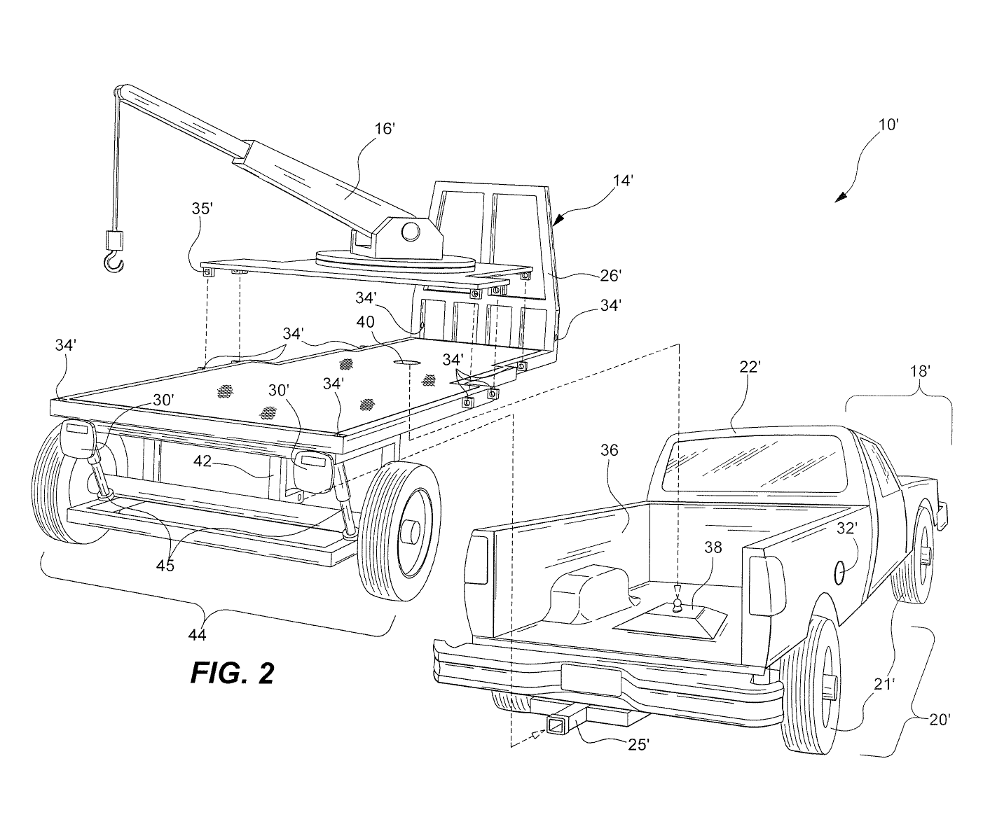

FIG. 2 shows a convertible vehicle 10′ according to another embodiment of the present invention similar to the convertible vehicle 10 of FIG. 1, except as described below. Structure repeated from the description of FIG. 1 includes the same reference numeral and a prime (′) symbol. As shown in FIG. 2, the rear portion 20′ of the vehicle frame 12′ further includes a truck bed 36 and a sub-frame coupler 38.

The truck bed 36 is coupled to the vehicle frame 12′. It is understood that the truck bed 36 may be coupled to the vehicle frame 12′ in a single manufacturing procedure. It is further understood that the truck bed 36 may be coupled to the vehicle frame 12′ in a post-manufacturing procedure such as welding, bolting, and other sufficient fastening means, as desired. The truck bed 36 may be any truck bed now used or later developed. As a non-limiting example, the truck bed 36 is a truck bed as manufactured by the original equipment manufacturer (OEM) of the vehicle frame 12′. As shown, the truck bed 36 includes a fuel inlet 35′ adapted to provide an access point and fluid conduit for delivering fuel to the convertible vehicle 10′. It is understood that additional components and systems may be included on the truck bed 36, as desired.

The sub-frame coupler 38 is disposed in the truck bed 36 and adapted to releasably couple to the sub-frame 14′. As shown, the sub-frame coupler 38 is a conventional gooseneck hitch securely mounted on the truck bed 36. However, it is understood that other couplers and securing means may be used, as desired.

In the embodiment shown in FIG. 2, the sub-frame 14′ further includes a first coupler 40 adapted to releasably couple the sub-frame 14′ to the truck bed 36 and a second coupler 42 adapted to releasably couple to the hitch receiver 25′ of the vehicle frame 12′. As shown, the first coupler 40 is an aperture formed in the sub-frame 14′ and adapted to receive the gooseneck hitch of the truck bed 36. However, it is understood that other couplers and securing means may be used, as desired. The second coupler 42 is adapted to engage the hitch receiver 25′ of the vehicle frame 12′ to provide additional support to the sub-frame 14′. As shown, a portion of the sub-frame 14′ extends past the rear portion 20′ of the vehicle frame 12′. A dolly system 44 or tag axle is included to support the extended portion of the sub-frame 14′. As shown, the dolly system 44 is coupled to the extended portion of the sub-frame 14′ and includes a separate suspension system 45. However, it is understood that any dolly system 44 may be used, as desired.

In use, the sub-frame 14′ is coupled to the truck bed 36 and the hitch receiver 25′. The sub-frame 14′ is releasably coupled to various quick-change attachments 16′ that would normally be permanently fastened to the rear portion 20′ of the vehicle frame 12′. As such, various attachments 16′ are interchangeably and releasably coupled to the sub-frame 14′ and thereby the vehicle frame 12′ for supporting the attachment. Once coupled, the attachment 16′ may be used to perform various utility functions associated with the design and nature of the attachment 16′. As shown, the attachment 16′ is a wrecker boom. However, when the user desires a new utility function, another attachment 16′ may be releasably coupled to the sub-frame 14′. In the embodiment shown in FIG. 2, the first coupler of the sub-frame 14′ is coupled to the sub-frame coupler of the truck bed and the second coupler is coupled to the hitch receiver 25′ of the vehicle frame 12′. The mounting brackets 35′ of the attachment 16′ engage the coupling devices 34′ of the sub-frame 14′ and locking pins are used to secure the attachment 16′ to the sub-frame 14′. The attachment 16′ is further interconnected to the electrical system of the sub-frame 14′ for providing electrical power to the attachment. It is understood that other means of releasably coupling the attachment 16′ to the sub-frame 14′ may be used, as desired. It is further understood that the attachment 16′ may be interconnected to other systems and devices of the sub-frame 14′ and vehicle frame 12′, as desired. Where a portion of the sub-frame extends past the truck bed 36′ and the vehicle frame 12′, the dolly system provides additional support to the sub-frame 14′

The convertible vehicle 10, 10′ provides a means to maximize the usefulness of a utility vehicle. The interchangeable and releasable attachments 16, 16′ are designed to function in a substantially similar fashion to that of the permanent utility elements currently used. Accordingly, the convertible vehicle 10, 10′ maximizes utility options while minimizing the number of separate utility vehicles required by the user.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A convertible vehicle comprising:
a vehicle frame adapted to support the convertible vehicle; and
a sub-frame coupled to the vehicle frame, the sub-frame including a coupling device adapted to releasably couple an attachment to the sub-frame.

2. The vehicle according to claim 1, wherein the attachment is at least one of a fifth wheel hitch, a wrecker boom, a lift gate, a box bed, a lifting device, a motorcycle lift, a gooseneck hitch, a winch, a fork lift, a platform lift, a ramp, a dump bed, and a liquid tank.

3. The vehicle according to claim 1, wherein the vehicle frame includes at least one of a plurality of ground engaging wheels, a driver cabin, a fuel tank, a hitch receiver, a hydraulic system, an electrical system, and a PTO system.

4. The vehicle according to claim 1, wherein the sub-frame further includes at least one of a headache rack, a plurality of fenders, a lighting system, and a fuel inlet.

5. The vehicle according to claim 1, wherein the attachment includes a mounting bracket adapted to be coupled to the coupling device of the sub frame.

6. The vehicle according to claim 5, wherein the coupling device is an aperture adapted to receive the mounting bracket of the attachment.

7. The vehicle according to claim 1, wherein the sub-frame is adapted to receive at least one of a hydraulic system, an electrical system, an underbody tool box, a pump, a motor, a cable winch, a gear reducer, a reservoir, a hose, a control system, a tag hitch receiver, and a power supply.

8. A convertible vehicle comprising:
a vehicle frame having a plurality of ground engaging wheels and a driver cabin, the vehicle frame adapted to support the convertible vehicle; and
a sub-frame coupled to the vehicle frame, the sub-frame including a coupling device adapted to releasably couple an attachment to the sub-frame.

9. The vehicle according to claim 8, wherein the attachment is at least one of a fifth wheel hitch, a wrecker boom, a lift gate, a box bed, a lifting device, a motorcycle lift, a gooseneck hitch, a winch, a fork lift, a platform lift, a ramp, a dump bed, and a liquid tank.

10. The vehicle according to claim 8, wherein the vehicle frame includes at least one of a fuel tank, a hitch receiver, a hydraulic system, an electrical system, and a PTO system.

11. The vehicle according to claim 8, wherein the sub-frame further includes at least one of a headache rack, a plurality of fenders, a lighting system, and a fuel inlet.

12. The vehicle according to claim 8, wherein the attachment includes a mounting bracket adapted to be coupled to the coupling device of the sub frame.

13. The vehicle according to claim 12, wherein the coupling device is an aperture adapted to receive the mounting bracket of the attachment.

14. The vehicle according to claim 8, wherein the sub-frame is adapted to receive at least one of a hydraulic system, an electrical system, an underbody tool box, a pump, a motor, a cable winch, a gear reducer, a reservoir, a hose, a control system, a tag hitch receiver, and a power supply.

15. A convertible vehicle comprising:
a vehicle frame having a plurality of ground engaging wheels, a driver cabin, and a truck bed, wherein the vehicle frame is adapted to support the convertible vehicle; and
a sub-frame coupled to the truck bed, the sub-frame including a coupling device adapted to releasably couple an attachment to the sub-frame.

16. The vehicle according to claim 15, wherein the attachment is at least one of a fifth wheel hitch, a wrecker boom, a lift gate, a box bed, a lifting device, a motorcycle lift, a gooseneck hitch, a winch, a fork lift, a platform lift, a ramp, a dump bed, and a liquid tank.

17. The vehicle according to claim 15, wherein the vehicle frame includes at least one of a fuel tank, a fuel inlet, a hitch receiver, a hydraulic system, an electrical system, and a PTO system.

18. The vehicle according to claim 15, wherein the sub-frame further includes at least one of a headache rack, a plurality of fenders, a lighting system.

19. The vehicle according to claim 15, wherein the attachment includes a mounting bracket adapted to be coupled to the coupling device of the sub frame.

20. The vehicle according to claim 15, wherein the sub-frame is adapted to receive at least one of a dolly system, a tag axle, a hydraulic system, an electrical system, an underbody tool box, a pump, a motor, a cable winch, a gear reducer, a reservoir, a hose, a control system, a tag hitch receiver, and a power supply.
